(19) United States
(12) Patent Application Publication
(10) Pub. No.: US 2010/0042028 A1
(43) Pub. Date: Feb. 18, 2010

(54) FOOT WRAP WITH INFLATABLE BLADDER

(75) Inventors: Mary H. Frank, Cookeville, TN (US); William M. Davidson, Knoxville, TN (US); Shane C. Bruce, Lenoir City, TN (US)

Correspondence Address: BAKER, DONELSON, BEARMAN, CALDWELL & BERKOWITZ;Intellectual Property Department, Monarch Plaza, Suite 1600, 3414 Peachtree Rd., ATLANTA, GA, 30326, US

(73) Assignee: ALBAHEALTH, LLC, Rockwood, TN (US)

(21) Appl. No.: 12/191,719

(22) Filed: Aug. 14, 2008

(51) Int. Cl. A61H 23/04; A61H 7/00

(52) U.S. Cl. 601/152; 601/151

(57) ABSTRACT

A foot wrap (10) is disclosed having a generally non-stretchable, flexible binding (11), a generally stretchable panel (12) coupled to the binding, an expandable, rotatable bladder (14), and a support pad (16) coupled to the binding opposite the bladder (14). The binding has a central portion (19) straddled by a first wing (21), a second wing (22), and an elastic heel band (23). The bladder measures approximately 3 inches by 3 inches and is designed to increase in height approximately 1½ to 1¾ inches with its inflation.

### TECHNICAL FIELD

This invention relates to foot wraps for pneumatically applying pressure to the foot to improve circulation in a limb extremity.

### BACKGROUND OF THE INVENTION

Walking or running is known to increase circulation in the leg because doing so puts pressure on the venous plexus vein located on the arch portion of a foot. Foot wraps have been used to increase blood circulation by simulating walking or running upon the venous plexus vein. This is accomplished by cyclically inflating a bladder housed within a foot wrap so that the bladder applies pressure upon the venous plexus vein. In order for a foot wrap to be beneficial to the user, it must be properly placed underneath the arch and air from a pneumatic pump coupled to the foot wrap must continually travel through a conduit to cyclically inflate and deflate the bladder within the foot wrap. A problem associated with prior art foot wraps is that there construction does not provide maximum compression of the venous plexus vein with each inflation of the bladder.

Accordingly, it is seen that a need remains for a foot wrap that provides maximum pressure to the venous plexus vein with each inflation of the bladder. It is to the provision of such therefore that the present invention is primarily directed.

### SUMMARY OF THE INVENTION

In a preferred form of the invention a foot wrap comprises a support pad, a non-stretchable binding coupled to the support pad, the non-stretchable binding having at least a central portion overlaying the support pad, and a stretchable panel overlying the non-stretchable binding central portion. The stretchable panel and the non-stretchable binding central portion define a bladder chamber. The foot wrap also includes an expandable bladder positioned within the bladder chamber. With this construction, the expansion of the bladder is restricted from expanding in one direction by the non-stretchable binding central portion but allowed to readily expand in an opposite direction by the stretchable panel.

### BRIEF DESCRIPTION OF THE DRAWING

FIG. 1 is a perspective view of a foot wrap, shown with a portion removed, embodying principles of the invention in a preferred form.

FIG. 2 is a perspective view of the foot wrap of FIG. 1 shown mounted to a foot.

FIG. 3 is a cross-sectional view of the foot wrap of FIG. 1, shown with a bladder in a deflated condition.

FIG. 4 is a cross-sectional view of the foot wrap of FIG. 1, shown with a bladder in an inflated condition.

FIG. 5 is a bottom view of a foot showing the placement of a bladder of the foot wrap of FIG. 1.

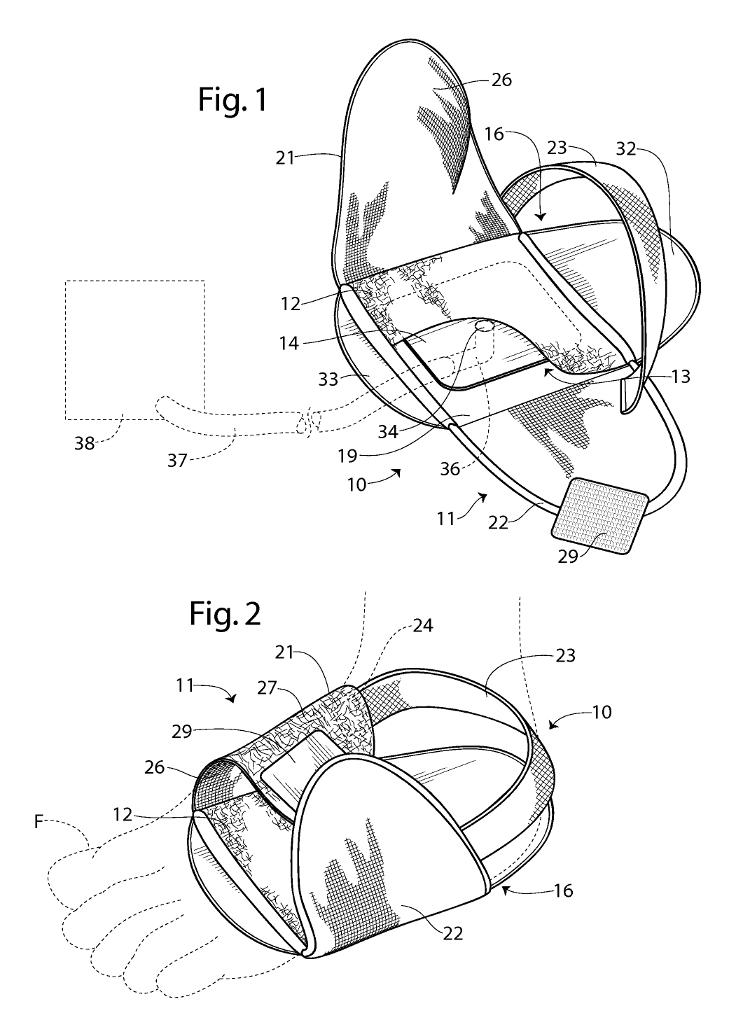

### DETAILED DESCRIPTION

With reference next to the drawings, there is shown a foot wrap 10 in a preferred form of the invention. The foot wrap 10 includes a generally non-stretchable binding or wrap portion 11, a generally stretchable panel 12 coupled to the binding 11 along at least a portion of its peripheral margin so as to define a bladder chamber 13 therebetween, an expandable bladder 14 positioned within the bladder chamber 13, and a support pad 16 coupled to the binding 11 opposite the bladder 14.

The binding 11 has a central portion 19 straddled by a first wing 21, a second wing 22 opposite the first wing 21, and an elastic heel band 23 fixed to the first wing 21 and removably coupled to the second wing 22 through a hook type fastener 24 mounted to the end of the band. The first wing 21 has an inner layer 26 comprised of a generally non-stretchable woven material. It should be understood that most materials have some quantity of stretch associated with the material, as such as used herein the term generally non-stretchable woven material is intended to reflect a flexible material which has a minimal amount of stretch such as a plain weave material which utilizes spun yarns with a poly/cotton blend and a weight characteristic of 4 to 7 ounces per square yard. The first wing 21 also has an outer layer 27 comprised of a unbroken loop (UBL) material, such as a brushed nylon, as for example that manufactured by Gehring Textiles, Inc. of New York, N.Y. under model number 1788 or by Rentex mills, Inc. of Mont-Royal, Quebec, Canada under model number R6026. The outer layer 27 is suitable as the loop portion of hook and loop type fasteners. The central portion 19 and second wing 22 are made of the same non-stretchable woven material as the inner layer 26 of the first wing, and as such, may be made of unitary construction therewith. The second wing 22 also includes a tab 29 of hook type fasteners which are capable of releasably fastening to the outer layer 27 of first wing 21.

The generally stretchable panel 12 is also comprised of an unbroken loop (UBL) material which may be the same as that previously described. The panel 12 material is stretchable to allow the unencumbered inflation of the bladder 14, i.e., it stretches upon inflation of the bladder so as not to substantially restrict such from occurring.

The support pad 16 has a central panel 31, a heel panel 32 and a forward panel 33. The heel panel and forward panel are pivotal relative to the central panel. The central panel 32 has a central hole 34 therethrough. The support pad 16 may be made of polyethylene (PET) foam material.

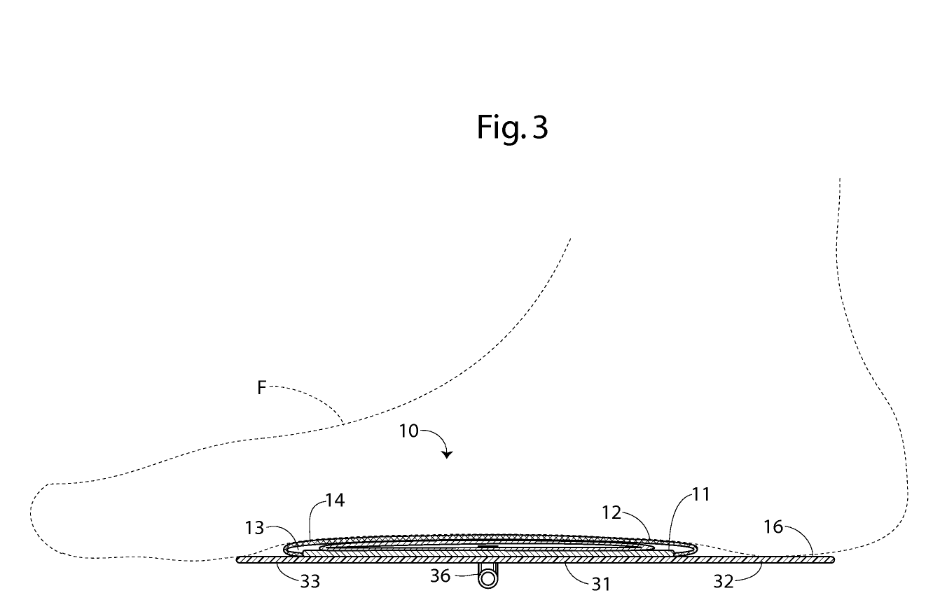

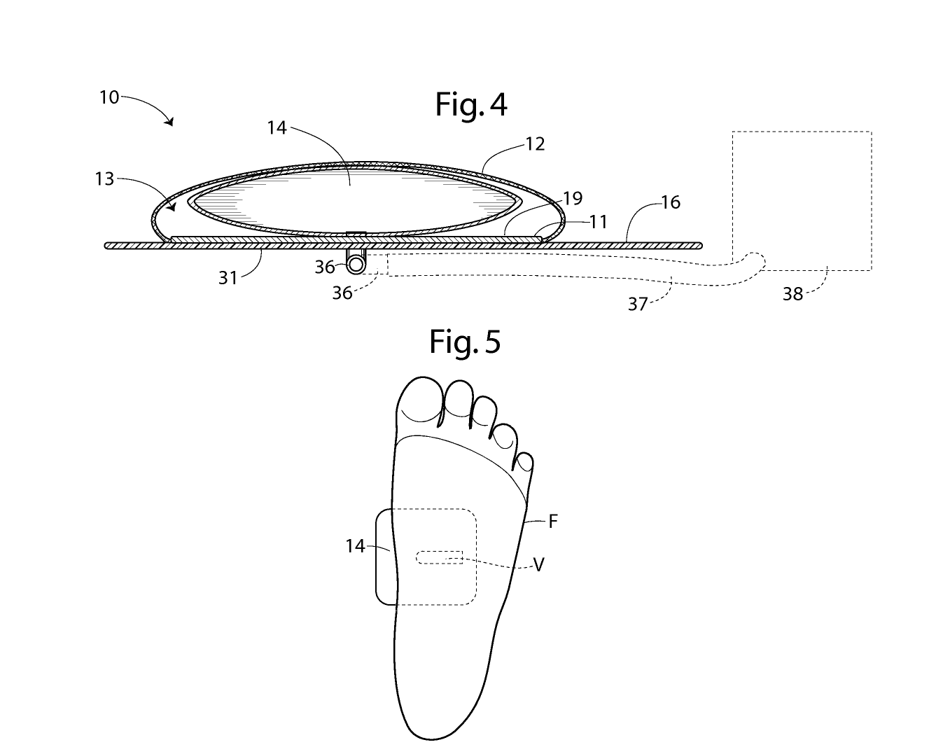

The bladder 14 may be made of an 11 mil vinyl material. The bladder 14 measures approximately 3 inches by 3 inches and is generally square in shape. Of course, it should be understood that the bladder may be of different dimensions and of different shapes. With this configuration, the bladder's height, as shown in FIGS. 3 and 4 of the drawings, increases to approximately 1½ to 1¾ inches with its inflation. The bladder 14 has a centrally positioned L-shaped intake coupler 36, which extends through hole 34 within the support pad central panel 31. The intake coupler 36 is coupled to a pneumatic line or hose 37 coupled at its opposite end to a pneumatic pump 38 which cyclically inflates and deflates the bladder, such as an intermittent compression pump made by Albahealth, LLC of Rockwood, Tenn., under the trade name PAS II Pulsatile.

In use, the foot wrap 10 is mounted to a person's foot F by positioning the foot upon the support pad 16, wrapping the first wing 21 about the top of the foot, wrapping the second wing 22 about the top of the foot and first wing and engaging the hook fasteners of tab 29 to the outer layer 27 of the first wing. The heel band 23 is then stretched and wrapped about the heel of the foot and coupled to the outer layer 27 of the first wing 21 through the hook type fastener 24. The bladder 14 should be positioned directly below the venous plexus vein V. The mounted foot wrap 10 is best shown in FIGS. 2 and 5.

With the bladder 14 coupled to an intermittent compression pump 38 through the hose 37 and intake coupler 36, the passage of pressurized air into the bladder 14 causes the bladder to inflate and thereby expand. The expansion of the bladder 14 is restricted in the direction opposite to the foot by the non-stretchable characteristic of the wrap binding 11, but unrestricted in the opposite direction, towards the foot, by the stretchable characteristic of the stretchable panel 12. As such, the expanding movement of the bladder 14 is deflected or concentrated towards the wearer's foot and onto the venous plexus vein. This concentrated movement of the bladder is a departure from the prior art devices which generally allow unrestricted movement of the bladder in all directions, thereby causing some forces associated with the inflation of the bladder to be lost as the bladder expandes away from the foot. The present invention with its higher concentration of the bladder movement towards the foot allows the bladder to work more efficiently, i.e., requiring less air pressure and/or less bladder expansion per inflation cycle.

An additional benefit of the present invention is the rotatability of the bladder 14 within the bladder chamber 13. The rotation of the bladder 14 allows the intake coupler 36 and adjoining pneumatic hose 37 to be rotated 360 degrees to any position relative to the foot. This allows the hose 37 to be directed to the nearest egress to reduce the likelihood of kinking or pinching the hose or interference of the hose against the wearer of the foot wrap. Of course, it should be understood that the coupler 36 may also be made rotatable relative to the expanding portion of the bladder.

It should be understood that the foot wrap may be designed to exclude the support pad 16. However, such is not preferred as the support panel provides additional support and restriction of the bladder movement away from the foot.

It thus is seen that a foot wrap is now provided which maximizes the inflation force of a bladder. While this invention has been described in detail with particular references to the preferred embodiments thereof, it should be understood that many modifications, additions and deletions, in addition to those expressly recited, may be made thereto without departure from the spirit and scope of the invention as set forth in the following claims.

1. A foot wrap comprising,
a support pad;
a non-stretchable, flexible binding coupled to said support pad, said non-stretchable, flexible binding having at least a central portion overlaying said support pad;
a stretchable panel overlying said non-stretchable, flexible binding central portion, said stretchable panel and said non-stretchable, flexible binding central portion defining a bladder chamber, and
an expandable bladder positioned within said bladder chamber,
whereby the expansion of the bladder is restricted from expanding in one direction by the non-stretchable, flexible binding central portion, but allowed to readily expand in an opposite direction through the stretchable panel.

2. The foot wrap of claim 1 wherein said expandable bladder is configured to be positioned upon the venous plexus vein of a foot to which the foot wrap is mounted.

3. The foot wrap of claim 1 wherein said expandable bladder is rotatable relative to and within said bladder chamber.

4. The foot wrap of claim 1 wherein said binding includes a first wing extending from one side of said central portion and a second wing extending from an opposite side of said central panel, and wherein said binding includes a fastener adapted to releasably couple said first wing and said second wing together.

5. A foot wrap comprising,
a non-stretchable, flexible binding, said non-stretchable, flexible binding having at least a central portion overlaying said support pad;
a stretchable panel overlying said non-stretchable, flexible binding central portion, said stretchable panel and said non-stretchable, flexible binding central portion defining a bladder chamber, and
an expandable bladder positioned within said bladder chamber,
whereby the expansion of the bladder is restricted from expanding in one direction by the non-stretchable, flexible binding central portion, but allowed to readily expand in an opposite direction through the stretchable panel.

6. The foot wrap of claim 5 wherein said expandable bladder is configured to be positioned upon the venous plexus vein of a foot to which the foot wrap is mounted.

7. The foot wrap of claim 5 wherein said expandable bladder is rotatable relative to and within said bladder chamber.

8. The foot wrap of claim 5 wherein said binding includes a first wing extending from one side of said central portion and a second wing extending from an opposite side of said central panel, and wherein said binding includes a fastener adapted to releasably couple said first wing and said second wing together.

9. A foot wrap comprising,
a binding, said binding having at least a central portion overlaying said support pad;
a panel overlying said binding central portion, said panel and said binding central portion defining a bladder chamber, and
an expandable bladder positioned within said bladder chamber, said expandable bladder being configured to be rotatable relative to and within said bladder chamber.

10. The foot wrap of claim 9 wherein said binding has a non-stretchable central portion and wherein said panel is stretchable, whereby the expansion of the bladder is restricted from expanding in one direction by the non-stretchable, flexible binding central portion but allowed to readily expand in an opposite direction through the stretchable panel.

11. The foot wrap of claim 10 wherein said expandable bladder is configured to be positioned upon the venous plexus vein of a foot to which the foot wrap is mounted.

12. The foot wrap of claim 9 wherein said binding includes a first wing extending from one side of said central portion and a second wing extending from an opposite side of said central panel, and wherein said binding includes a fastener adapted to releasably couple said first wing and said second wing together.
